(19) United States
(12) Patent Application Publication
(10) Pub. No.: US 2025/0303753 A1
(43) Pub. Date: Oct. 2, 2025

(54) INFORMATION PROCESSING APPARATUS, INFORMATION PROCESSING METHOD, PRINTING APPARATUS, AND STORAGE MEDIUM

(71) Applicant: CANON KABUSHIKI KAISHA, Tokyo (JP)

(72) Inventor: Kanto Kurasawa, Tokyo (JP)

(21) Appl. No.: 19/089,234

(22) Filed: Mar. 25, 2025

(30) Foreign Application Priority Data
Mar. 29, 2024 (JP) 2024-057010

(51) Int. Cl. B41J 11/46; B41J 3/46; G06T 7/73

(52) U.S. Cl. CPC B41J 11/46; B41J 3/46; G06T 7/73; G06T 2207/10008; G06T 2207/30204

(57) ABSTRACT

A conveyance control unit starts splice detection with a splice detection unit and feed of a roll sheet. In a case where the splice detection unit detects splice tape, the conveyance control unit feeds the sheet to a scanner while measuring the amount of the sheet feed. A scanner control unit reads the roll sheet over a predetermined distance with the scanner to obtain a read image for the predetermined distance. The scanner control unit performs an image analysis for detecting an eye mark on the read image obtained by the reading with the scanner, and determines whether an eye mark is detected from the read image. In a case where an eye mark is detected, the scanner control unit calculates a distance on a scale indicating the position of an eye mark sensor to be subjected to sensor positioning, and displays the distance on an operation panel.

### BACKGROUND

### Field

The present disclosure relates to an information processing technique for assisting setup of a printing apparatus.

### Description of the Related Art

Some printing apparatuses for performing printing on a roll sheet are capable of adjusting their print positions such that the position of a positioning mark printed on the roll sheet in advance (hereinafter referred to as “eye mark”) is set as a reference position of the head of a page. A technique disclosed in Japanese Patent Laid-Open No. 2016-175216 involves detecting the position of an edge of a roll sheet and correcting the position of a detection sensor (hereinafter referred to as “eye mark sensor”) based on the result of the detection to achieve stable detection of eye marks even in a case where the roll sheet meanders.

Here, a problem with Japanese Patent Laid-Open No. 2016-175216 is that, to determine the initial position of the eye mark sensor in the sheet width direction based on the print position of eye marks, the user needs to feed the roll sheet to align the positions of an eye mark and the eye mark sensor with each other, which requires time and effort. Determining the initial position of the eye mark sensor in the sheet width direction involves firstly feeding the sheet to align the sensing position of the eye mark sensor and the position of an eye mark with each other in the sheet conveyance direction, and then align these positions with each other in the sheet width direction. While the user needs to perform these positioning operations by eye, performing quick and accurate sheet feed by eye is not easy and is a task that requires the user's significant effort especially in a case where the roll sheet is heavy.

### SUMMARY

The present disclosure provides an information processing apparatus including: an obtaining unit that obtains a read image obtained by reading a print medium on which is printed a mark indicating a print position with a reading unit included in a printing apparatus; a determination unit that determines, using the read image, a position in a sheet width direction of the print medium at which the mark is detectable by a detection unit based on a distance in the sheet width direction between a reference position of the detection unit and a reference position of the reading unit, wherein the detection unit is included in the printing apparatus and detects the mark; and an output unit that outputs position information indicating the position determined by the determination unit.

Further features of the present disclosure will become apparent from the following description of exemplary embodiments with reference to the attached drawings.

### BRIEF DESCRIPTION OF THE DRAWINGS

FIG. 1 is a simplified view of a conveyance path in a printing apparatus in a standby state;

FIG. 2 is a simplified view of an eye mark sensor and eye marks;

FIG. 3 is a schematic diagram of a control configuration in the printing apparatus;

FIG. 4 is a view illustrating a state before sensor positioning;

FIG. 5 is a view illustrating a state after the operation of a procedure 1 for the sensor positioning;

FIG. 6 is a view illustrating a state after the operation of a procedure 2 for the sensor positioning;

FIG. 7 is a flowchart illustrating an eye mark position reading process in Embodiment 1;

FIG. 8 is a view illustrating distances between eye marks, an eye mark sensor, and a scanner;

FIG. 9A is a view illustrating an amount of sheet feed in a step in the eye mark position reading process in Embodiment 1;

FIG. 9B is a view illustrating an amount of sheet feed in a step in the eye mark position reading process in Embodiment 1;

FIG. 9C is a view illustrating an amount of sheet feed in a step in the eye mark position reading process in Embodiment 1;

FIG. 9D is a view illustrating an amount of sheet feed in a step in the eye mark position reading process in Embodiment 1; and

FIG. 10 is a view illustrating a slide guide equipped with a moving apparatus that moves an eye mark sensor in the sheet width direction in Embodiment 2.

### DESCRIPTION OF THE EMBODIMENTS

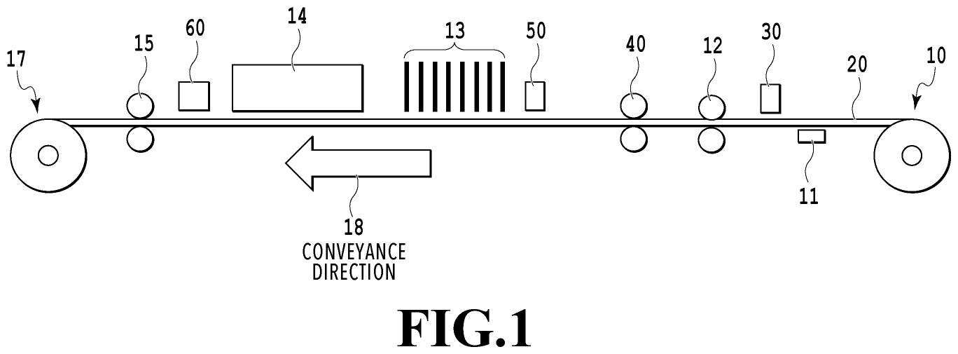

FIG. 1 is a simplified side view of a conveyance path in a printing apparatus used in the following embodiments in a case where the printing apparatus is in a standby state. While the conveyance path is simplified and depicted in a straight shape in FIG. 1, a roll sheet as a print medium is actually conveyed along a path that assumes a large S-shape. The roll sheet is slacked off between a sheet feed apparatus 10 and a main conveyance unit 12 and between a sub conveyance unit 15 and a winding apparatus 17, and dancer rollers (not illustrated) are also provided to prevent the slacks from giving any impact. The main conveyance unit 12 includes an encoder (not illustrated) capable of measuring the amount of rotation of its rollers. Also, the sheet feed apparatus 10 is provided on the right side of the printing apparatus, and the roll sheet is mounted there.

A splicing table 11 and a splice detection unit 30 are provided downstream of the sheet feed apparatus 10. In a case of replacing the roll sheet, the user cuts the roll sheet on this splicing table 11, replaces the roll sheet mounted on the sheet feed apparatus 10 with another one, and splices it to the trailing end of the existing roll sheet that has been cut and remaining in the printing apparatus with splice tape on the splicing table 11. In this way, replacement of the roll sheet can be done by simply passing a new roll sheet to the splicing table 11 from the sheet feed apparatus 10. The splice detection unit 30 detects the spliced portion of the roll sheet to which the splice tape is attached. The roll sheet is conveyed by its portions nipped by the main conveyance unit 12 and the sub conveyance unit 15. A meandering correction apparatus 40 that corrects and stabilizes the position of the roll sheet in the width direction during its conveyance to correct meandering of the roll sheet is provided downstream of the main conveyance unit 12.

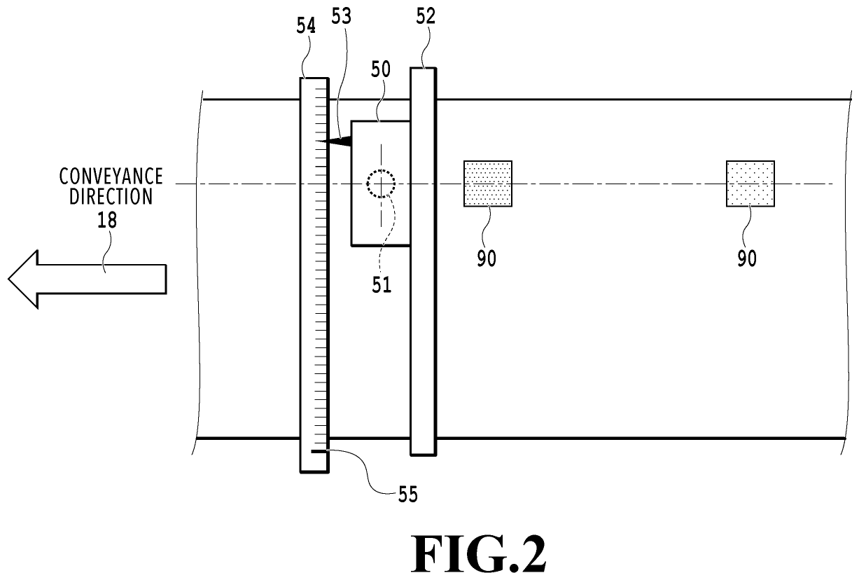

As illustrated in FIG. 2, an eye mark sensor 50 is an edge sensor that senses eye marks 90 printed on the roll sheet in advance in order to determine a print start position of each page, and has a sensing range 51 as a detection range within which the eye mark sensor 50 can detect an eye mark 90. The eye mark sensor 50 is manually movable in the roll sheet width direction along a slide guide 52. Its position in the roll sheet width direction can be measured with a scale 54 having a pointer 53 attached to the eye mark sensor 50 and a scale origin 55. In the present embodiment, the position of the scale origin 55 is a reference position on the scale 54.

A printing unit is present downstream of the eye mark sensor 50 in the conveyance direction, and includes one head 13 for each of predetermined colors. The printing unit ejects inks onto the roll sheet conveyed in a print direction 18 to perform printing. The printed roll sheet is dried by a dryer with a heater or the like included in a fixing unit 14 and cooled by a cooler with a fan included in the fixing unit 14. The cooled roll sheet is passed through the sub conveyance unit 15 and wound up by the winding apparatus 17.

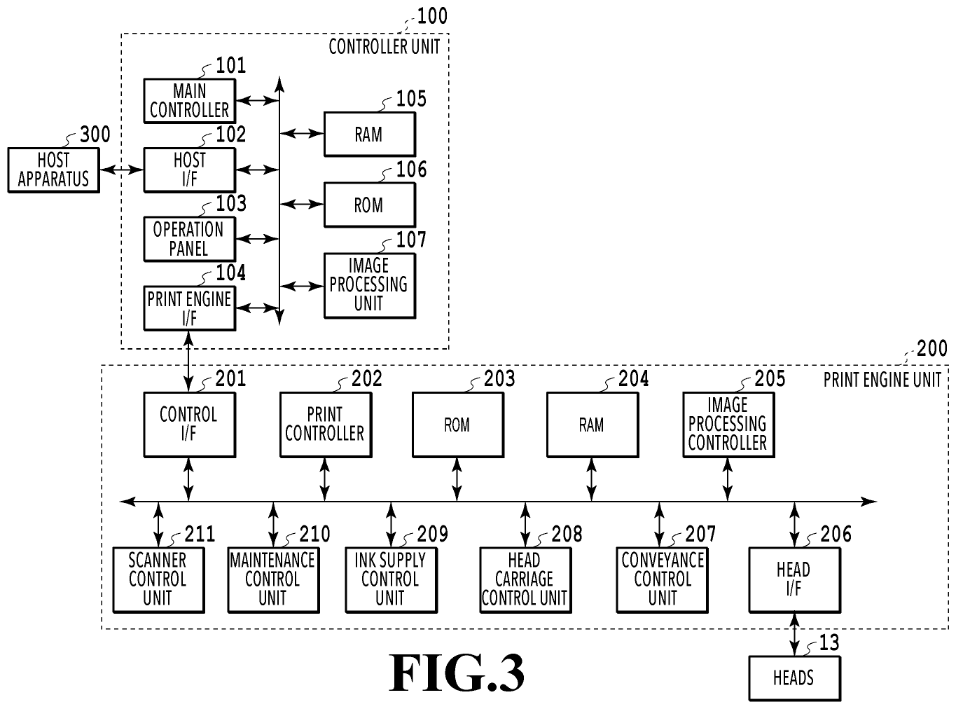

FIG. 3 is a block diagram illustrating a control configuration in the printing apparatus. The control configuration mainly includes a controller unit 100 that comprehensively controls the printing apparatus and a print engine unit 200 that controls a print engine. A print controller 202 controls various mechanisms of the print engine unit 200 by following instructions from a main controller 101 of the controller unit 100 received via a controller interface (I/F) 201. Details of the control configuration will now be described below.

In the controller unit 100, the main controller 101, which is a central processing unit (CPU), comprehensively controls the printing apparatus according to a program and various parameters stored in a read-only memory (ROM) 106 with a random-access memory (RAM) 105 as a work area. For example, in a case where a print job is input from a host apparatus 300 via a host I/F 102, an image processing unit 107 performs predetermined image processing on received image data by following an instruction from the main controller 101. The main controller 101 then sends the image data subjected to the image processing to the print engine unit 200 via a print engine I/F 104.

Note that the printing apparatus may obtain the image data from an external storage apparatus (such as a universal serial bus (USB) flash drive) connected thereto. An operation panel 103 is an input-output apparatus that functions as a display apparatus which is controlled to display information of the printing apparatus and also an input apparatus with which the user gives inputs to the printing apparatus. Via the operation panel 103, the user can, for example, give instructions to perform operations such as printing and sheet feed, set a print mode, and recognize information on the printing apparatus. The operation panel 103 is a touch panel, and a mouse and a keyboard can be connected thereto to give inputs.

In the print engine unit 200, the print controller 202, which is a CPU, controls various mechanisms included in the printing apparatus according to a program and various parameters stored in a ROM 203 with a RAM 204 as a work area. In a case where various commands and image data are received from the controller unit 100 via the controller I/F 201, the print controller 202 temporarily saves these in the RAM 204. The print controller 202 converts the saved image data into print data which the heads 13 can use in a printing operation by using an image processing controller 205. The print controller 202 causes the heads 13 to execute a printing operation based on the print data via a head I/F 206. At this time, the print controller 202 conveys the roll sheet, which is a print medium, by driving the sheet feed apparatus 10, the main conveyance unit 12, the sub conveyance unit 15, and the winding apparatus 17 illustrated in FIG. 1 via a conveyance control unit 207. Also, the conveyance control unit 207 is capable of detecting the amount of sheet feed from the encoder, which is provided to a conveyance roller. The print controller 202 performs print processing by executing the printing operation with the heads 13 at a predetermined timing after the eye mark sensor 50 detects an eye mark 90.

The heads 13 are configured to be movable in the direction normal to the roll sheet to change the distances between them and the roll sheet. The heads 13 can be placed at positions close to the roll sheet during printing as illustrated in FIG. 1, and moved to positions far from the roll sheet during maintenance and the like. A head carriage control unit 208 changes the distances between the heads 13 and the roll sheet according to the operating status of the printing apparatus such as whether the printing apparatus is in a maintenance state or in a printing state. An ink supply control unit 209 controls an ink supply unit such that the pressures on the inks to be supplied to the heads 13 stay within appropriate ranges. In a case of performing a maintenance operation on the heads 13, a maintenance control unit 210 moves a maintenance unit (not illustrated) to under the heads 13 separated from the roll sheet and controls the maintenance operation on the heads, such as capping and wiping.

The printing apparatus includes the eye mark sensor 50, which detects eye marks on the roll sheet, and a scanner 60 which reads the roll sheet across the entire width of the sheet to generate a read image.

A scanner control unit 211 controls the scanner 60 and performs an image analysis on the read image obtained by reading the roll sheet. Based on the image analysis, for example, the position of an eye mark 90 on the sheet surface is detected, and ejection misalignment is detected from a particular ejection pattern (registration adjustment pattern) for adjusting the print position.

For each roll sheet, the eye marks 90 on the roll sheet are formed at any position in the sheet width direction at predetermined intervals in the conveyance direction. The eye mark sensor 50, which is a spot sensor with a small sensing range 51, needs sensor positioning in which the eye mark sensor 50 is moved to an appropriate position in the sheet width direction along the slide guide 52 so that each eye mark 90 will enter the sensing range 51. In the sensor positioning in the present embodiment, a position at which the center of the sensing range 51 and the centers of the eye marks 90 align with each other in the sheet width direction is determined as the appropriate position of the eye mark sensor 50.

Each roll sheet differs in the position at which the eye marks 90 are formed on the roll sheet. The sensor positioning is therefore performed in a case where the roll sheet is replaced. In the following, a description will be given of a use case in which replacement of a roll sheet is followed by sensor positioning as a preparatory operation before starting printing on the new roll sheet.

### <Conventional Sensor Positioning Procedure>

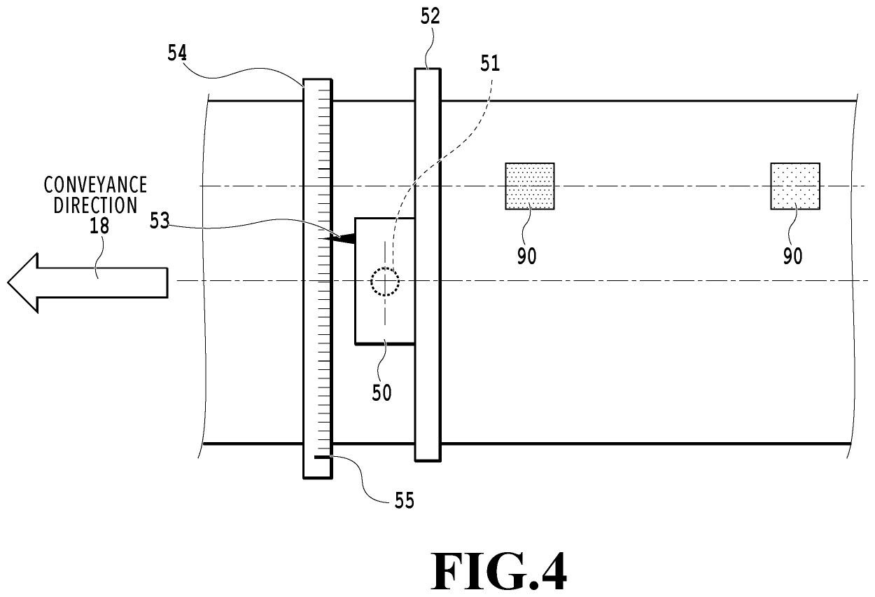

A description will be given of a conventional procedure for performing sensor positioning in a state where the positions of the sensing range 51 and the eye marks 90 in the sheet width direction are misaligned as illustrated in FIG. 4. Note that, during the sensor positioning, the eye mark sensor 50 emits a visible light beam indicating a reference position indicating the sensing range 51 on the sheet surface, and the user can figure out the sensing range 51 based on the position to which that visible light beam is emitted.

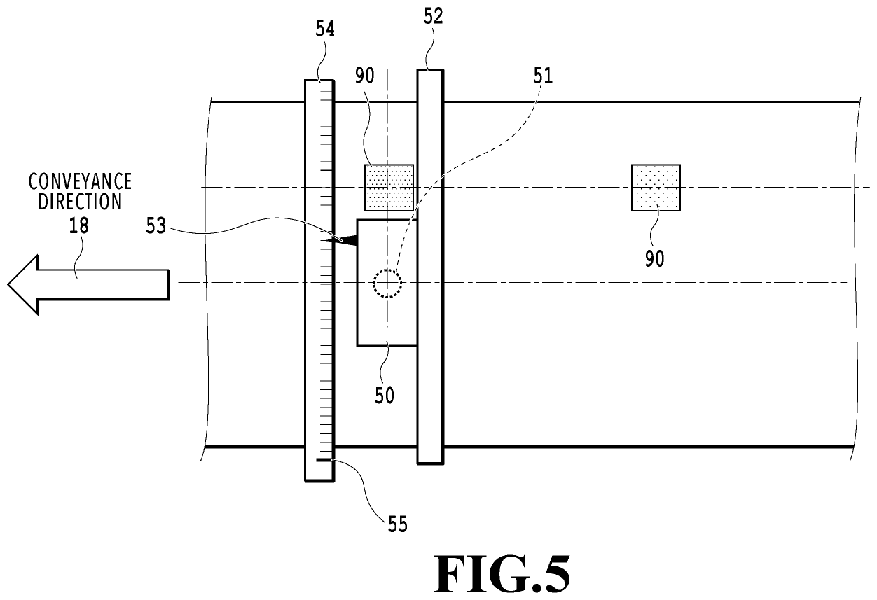

Procedure 1: As illustrated in FIG. 5, the user feeds the roll sheet (sheet feed) to a position at which the position of the center of one of the eye marks 90 aligns with the center of the sensing range 51 in the conveyance direction and then stops the sheet feed by eye. The user may perform this feed of the roll sheet manually or by using a sheet feed mechanism (not illustrated) included in the printing apparatus.

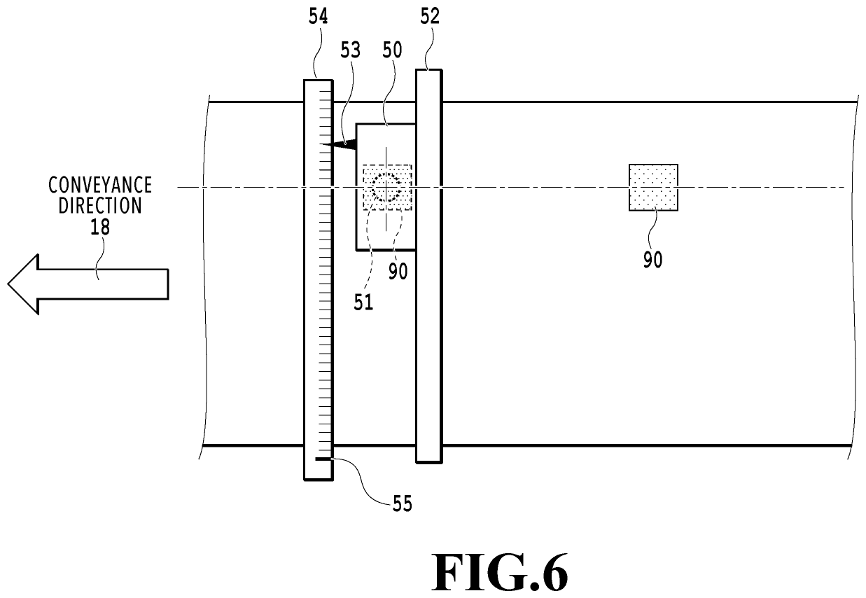

Procedure 2: As illustrated in FIG. 6, the user moves the eye mark sensor 50 by eye to a position in the sheet width direction at which the center of the sensing range 51 and the center of the eye mark 90 align with each other.

As described above, the conventional method requires the user to perform operations by eye in the procedures 1 and 2. In particular, the procedure 1 requires conveying the roll sheet to and stopping it at a target position, and it is generally difficult to perform an operation of subtly adjusting the conveyance especially in a case where the printer is large in size. The present disclosure is aimed at simplifying these operations based on visual judgment to enable easy sensor positioning for the user.

### Embodiment 1

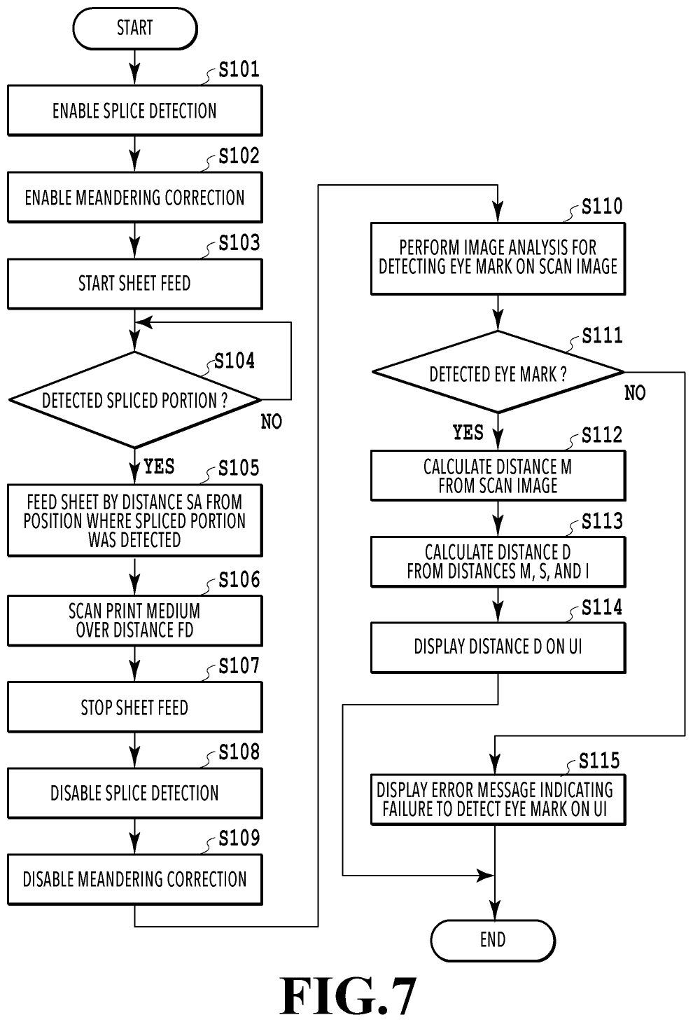

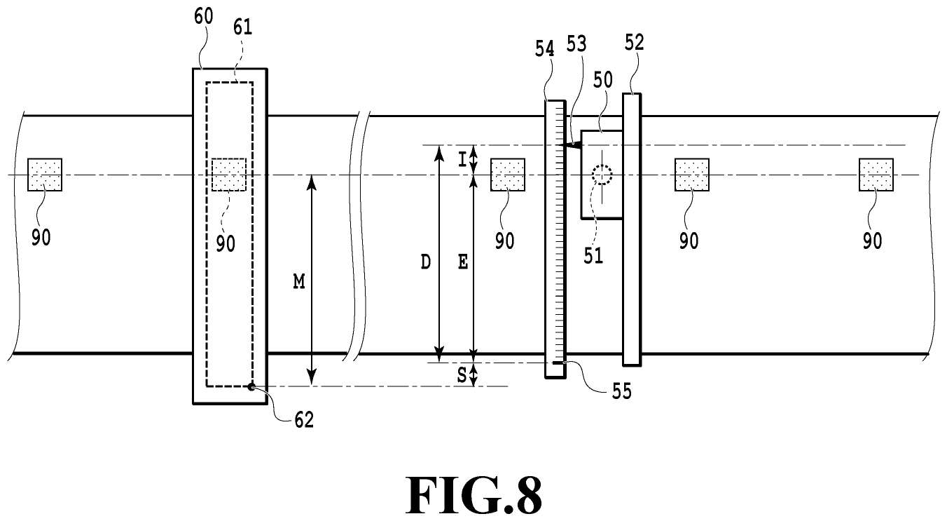

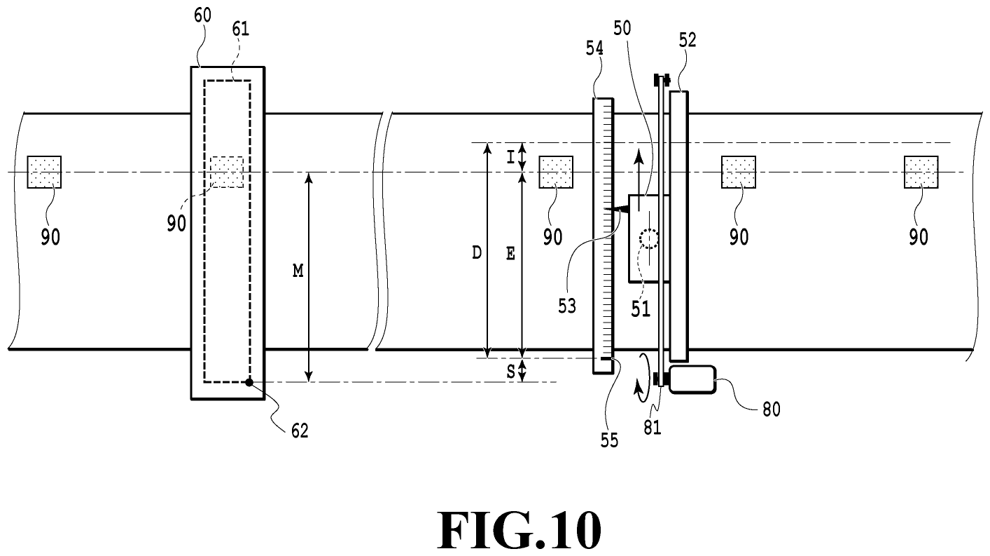

FIG. 7 is a flowchart illustrating an eye mark position reading operation in Embodiment 1. FIGS. 8 to 10 are simplified views of the apparatus. A printing sequence in the present embodiment will be described using these drawings.

FIG. 8 illustrates a state where the center position of the sensing range 51 of the eye mark sensor 50 and the position of the eye marks 90 align with each other in the sheet width direction. The scanner 60 has a scan region 61 within which the scanner 60 can scan the print surface of the roll sheet, and a scan region origin 62 which is the origin of that region and serves as a reference position of the scanner 60. The scanner 60 and the scale 54 are fixed to a frame of the main body of the printing apparatus. Thus, a distance S between the scan region origin 62 and the scale origin 55 in the sheet width direction is a fixed value. Also, the pointer 53 is fixed to the eye mark sensor 50. Thus, a distance I between the center of the sensing range 51 and the tip of the pointer 53 in the sheet width direction is a fixed value as well. These distances S and I are stored in the ROM 203. Also, distance derivation information such as the pixel-to-pixel distances in the sheet width direction for deriving the distances from the scan region origin 62 to the pixels of read images obtained by the scanner 60 is stored in the ROM 203 as well.

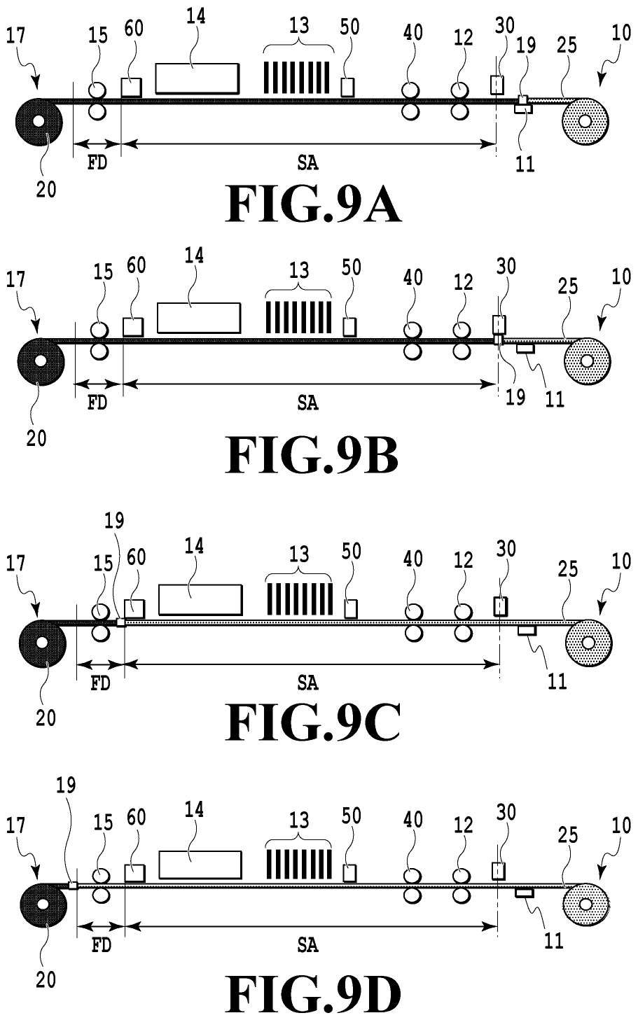

FIG. 9A illustrates a state where a roll sheet has been replaced with and spliced to another one with splice tape 19 on the splicing table 11. A following sheet 25 is mounted on the sheet feed apparatus 10, the leading end of the following sheet 25 and the trailing end of a preceding sheet 20 are placed in abutment with each other on the splicing table 11, and the splice tape 19 is attached to those ends to splice them. The distance between the splice detection unit 30 and the rear end of the scanner 60 in the conveyance direction is denoted as SA, and a distance in the conveyance direction from the rear end of the scanner 60 that is greater than or equal to the interval between adjacent eye marks 90 on the following sheet 25 is denoted as FD. These distances SA and FD are stored as predetermined fixed values in the ROM 203. Note that the distance FD is set to be greater than or equal to the interval between adjacent eye marks 90 because the positions, in the sheet width direction, of all of the multiple eye marks 90 formed on the roll sheet are the same on a per-roll basis, and it is sufficient to be able to detect the position of at least one eye mark 90.

FIG. 7 illustrates a flowchart describing the processing of sensor positioning performed in a case where a roll sheet is replaced in order to align the eye mark sensor 50 with the eye marks 90 on the following sheet 25. This processing is executed in response to the user instructing the print engine unit 200 to start this processing via the operation panel 103 on an as-needed basis, e.g., in a case where a roll sheet is replaced.

In S101, the conveyance control unit 207 starts splice detection with the splice detection unit 30.

In S102, the conveyance control unit 207 starts meandering control with the meandering correction apparatus 40.

In S103, the conveyance control unit 207 starts conveyance of the roll sheet, i.e., starts sheet feed, by driving the main conveyance unit 12, the sub conveyance unit 15, the sheet feed apparatus 10, and the winding apparatus 17.

In S104, the conveyance control unit 207 continues the detection until the splice detection unit 30 detects the splice tape 19. If the splice tape 19 reaches the inside of the detection range of the splice detection unit 30 (FIG. 9B) and the splice detection unit 30 detects the splice tape 19, the processing proceeds to S105.

In S105, the conveyance control unit 207 feeds the sheet by the predetermined distance SA while measuring the amount of sheet feed since the detection of the splice (FIG. 9C).

In S106, the scanner control unit 211 reads the roll sheet over the distance FD with the scanner 60 to obtain a read image for the distance FD (FIG. 9D).

In S107, the conveyance control unit 207 stops the sheet feed by stopping the main conveyance unit 12, the sub conveyance unit 15, the sheet feed apparatus 10, and the winding apparatus 17.

In S108, the conveyance control unit 207 ends the meandering control with the meandering correction apparatus 40.

In S109, the conveyance control unit 207 ends the splice detection with the splice detection unit 30.

In S110, the scanner control unit 211 performs an image analysis for detecting an eye mark 90 on the read image obtained by the reading with the scanner 60.

In S111, the scanner control unit 211 determines whether an eye mark 90 is detected from the read image. If an eye mark 90 is detected, the processing proceeds to S112. If no eye mark is detected, the processing proceeds to S115.

In S112, the scanner control unit 211 calculates a distance M between the position, in the sheet width direction, of a pixel corresponding to the center of the eye mark 90 in the read image and the scan region origin 62, which is a reference position of the scanner 60, and stores the distance M in the RAM 204.

In S113, the print controller 202 calculates a distance D on the scale 54 indicating the position of the eye mark sensor 50, which is the target of the sensor positioning, based on the distance M stored in the RAM 204 and the distances S and I stored in the ROM 203. Since the distances M, S, I, and D are in a relationship as illustrated in FIG. 8, the distance D can be derived as follows.

$$D = E + I \qquad ( 1 )$$

$$M = S + E \qquad ( 2 )$$

Equation (2) is transformed as follows.

$$E = M - S \qquad ( {2}^{′} )$$

From Equations (1) and (2′), the following is obtained.

$$D = M - S + I \qquad ( 3 )$$

In S114, the print controller 202 displays position information indicating the distance D on the operation panel 103, and the series of processes is terminated.

In S115, the scanner control unit 211 displays an error message indicating that an eye mark 90 could not be detected on the operation panel 103, and the series of processes is terminated.

The above processing allows position information indicating the distance D to be displayed on a user interface on the operation panel 103 or the like. Accordingly, the user can complete the sensor positioning by simply moving the eye mark sensor 50 such that the pointer 53 indicates the distance D on the scale 54. That is, the sensor positioning can be done without the user's positioning in the sheet conveyance direction by eye in the procedure 1, which is necessary in the conventional sensor positioning. This allows sensor positioning with simpler user operations.

Note that, in the present embodiment, the configuration is such that the scanner control unit 211 performs the process of performing an image analysis on a read image to detect an eye mark 90. Alternatively, the configuration may be such that an external information processing apparatus connected to the print engine unit 200 performs this process. Similarly, in the present embodiment, the configuration is such that the print controller 202 performs the process of calculating the distance D. Alternatively, the configuration may be such that an external information processing apparatus connected to the print engine unit 200 also performs this process.

Also, in the present embodiment, the configuration is such that the print medium is read over the distance FD in a single operation and the image analysis is performed on the resulting single read image. Alternatively, the configuration may be such that the reading of the print medium over the distance FD is performed in multiple separate operations and the image analysis is performed individually on the resulting multiple read images.

Also, in a case where a next spliced portion is detected between S105 and S106, S107 to S109 may be skipped for the read image corresponding to the spliced portion detected before that next spliced portion and the processes of S110 to S115 may be performed, and the processes from S105 may be performed for the next spliced portion.

### Embodiment 2

In Embodiment 1, the user having seen the distance D displayed on the operation panel 103 manually performs the sensor positioning. In Embodiment 2, a driving mechanism for moving the eye mark sensor 50 or the slide guide 52 in the sheet width direction is provided, and the sensor positioning is performed with the driving mechanism. The driving mechanism may be, for example, a mechanism capable of moving the eye mark sensor 50 in the sheet width direction of the roll sheet by moving the eye mark sensor 50 with a motor 80 through a driving belt 81. By controlling such a driving mechanism based on the relative positions of the pointer 53 and the scale 54 detected by a position sensor (not illustrated), it is possible to move the pointer 53, i.e., the eye mark sensor 50, to a designated position on the scale 54.

As described above, according to the present embodiment, the sensor positioning of the eye mark sensor 50 can be automatically completed without user operations. Specifically, the sensor positioning can be done without performing the user operations in the procedures 1 and 2 necessary in the conventional sensor positioning. This improves operability.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

According to the present disclosure, it is possible to adjust an eye mark sensor to an appropriate initial position with a simple operation.

This application claims the benefit of Japanese Patent Application No. 2024-057010 filed Mar. 29, 2024, which is hereby incorporated by reference wherein in its entirety.

What is claimed is:

1. An information processing apparatus comprising:
an obtaining unit that obtains a read image obtained by reading a print medium on which is printed a mark indicating a print position with a reading unit included in a printing apparatus;
a determination unit that determines, using the read image, a position in a sheet width direction of the print medium at which the mark is detectable by a detection unit based on a distance in the sheet width direction between a reference position of the detection unit and a reference position of the reading unit, wherein the detection unit is included in the printing apparatus and detects the mark; and
an output unit that outputs position information indicating the position determined by the determination unit.

2. The information processing apparatus according to claim 1, wherein the determination unit determines a position of the detection unit such that the mark will enter a detection range of the detection unit based on a distance in the sheet width direction between a center position of the detection range and the reference position of the reading unit and a distance in the sheet width direction between the reference position of the reading unit and a position of a pixel corresponding to the mark in the read image.

3. The information processing apparatus according to claim 1, wherein the print medium is a roll sheet.

4. The information processing apparatus according to claim 1, wherein a reading range of the reading unit is wider than a detection range of the detection unit.

5. The information processing apparatus according to claim 1, wherein the read image is a read image obtained by reading the print medium across an entire sheet width thereof.

6. The information processing apparatus according to claim 1, wherein the output unit outputs the position information to a display control unit of a display apparatus.

7. The information processing apparatus according to claim 1, wherein the output unit outputs the position information to a moving unit that moves the detection unit in the sheet width direction.

8. The information processing apparatus according to claim 1, wherein the determination unit determines the position in the sheet width direction at which the mark is detectable to the detection unit in a case where a joint is detected on the print medium.

9. The information processing apparatus according to claim 1, wherein the printing apparatus starts printing on a per-page basis based on a timing at which the detection unit detects the mark.

10. The information processing apparatus according to claim 1, wherein the reading unit is capable of measuring a registration adjustment pattern for adjustment of a print position.

11. A printing apparatus comprising:
the information processing apparatus according to claim 1;
the detection unit; and
the reading unit.

12. The printing apparatus according to claim 11, further comprising a moving unit that moves the detection unit in the sheet width direction based on the position information output from the output unit.

13. The printing apparatus according to claim 11, further comprising a display unit that displays the position information output from the output unit.

14. An information processing method comprising:
obtaining a read image obtained by reading a print medium on which is printed a mark indicating a print position with a reading unit included in a printing apparatus;
determining, using the read image, a position in a sheet width direction of the print medium at which the mark is detectable by a detection unit based on a distance in the sheet width direction between a reference position of the detection unit and a reference position of the reading unit, wherein the detection unit is included in the printing apparatus and detects the mark; and
outputting position information indicating the position determined by the determination unit.

15. A non-transitory computer readable storage medium storing a program which causes a computer to execute:
obtaining a read image obtained by reading a print medium on which is printed a mark indicating a print position with a reading unit included in a printing apparatus;
determining, using the read image, a position in a sheet width direction of the print medium at which the mark is detectable by a detection unit based on a distance in the sheet width direction between a reference position of the detection unit and a reference position of the reading unit, wherein the detection unit is included in the printing apparatus and detects the mark; and
outputting position information indicating the position determined by the determination unit.
